(19) United States
(12) Patent Application Publication
(10) Pub. No.: US 2004/0056856 A1
(43) Pub. Date: Mar. 25, 2004

(54) Data driver

(75) Inventors: Yasuyuki Doi, Kyoto (JP); Hirofumi Nakagawa, Kyoto (JP); Shiro Dosho, Osaka (JP); Yusuke Tokunaga, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD

(21) Appl. No.: 10/649,630

(22) Filed: Aug. 28, 2003

(30) Foreign Application Priority Data
Aug. 28, 2002 (JP) 2002-248241

(51) Int. Cl. G09G 5/00

(52) U.S. Cl. 345/208

(57) ABSTRACT

First, second, third and fourth inverters are serially connected to form an inverter chain. The first inverter receives a clock input. A first current source is connected to the power supply side of the first inverter. A second current source is connected to the ground side of the third inverter. If the duty ratio of a clock output is lower than a desired value, the magnitude of an electric current in the first current source is decreased such that the falling timing of the clock output is delayed. If the duty ratio of the clock output is higher than a desired value, the magnitude of an electric current in the second current source is decreased such that the rising timing of the clock output is delayed. With such an arrangement, the margins of the setup time and hold time between the clock and data are readily secured.

### BACKGROUND OF THE INVENTION

The present invention relates to a data driver incorporated in a display device, such as a liquid crystal panel, a plasma display panel, or the like, and specifically to a technique for securing the margins of a setup time and a hold time between a clock and data.

Japanese Unexamined Patent Publication No. 11-194748 discloses an arrangement where a plurality of data driver chips are aligned along a horizontal side of a liquid crystal panel, and neighboring data driver chips are connected by a single clock line and a plurality of data lines. Each of the data drivers receives a single clock signal and a plurality of data inputs. Each data driver supplies a predetermined data voltage to a liquid crystal display section and supplies a single clock output and a plurality of data outputs to an adjacent data driver.

The above arrangement has been applied to a liquid crystal panel which employs a well-known COG (Chip On Glass) technique for the purpose of cost reduction, and this is herein referred to as a serial COG arrangement.

Along with a frame size reduction in liquid crystal panels, restrictions on the size of data driver chips have been tightened. Moreover, along with an increase in the definition of liquid crystal panels, there has been an increasing demand for a higher speed data driver. However, in a conventional serial COG liquid crystal panel, a timing difference between a clock and data increases accumulatively while the clock and the data are transmitted among data drivers. This problem becomes more aggravated as the frequency of a clock input increases due to the higher definition. The problem can be solved by incorporating a PLL (Phase-Locked Loop) circuit in each data driver, but in such a case, the circuit size of the data driver increases.

### SUMMARY OF THE INVENTION

An objective of the present invention is to provide a technique for constantly securing the margins of a setup time and a hold time between a clock and data especially in a data driver designed for a serial COG liquid crystal panel.

In order to achieve the above objective, according to the present invention, the electric current flowing through an inverter is adjusted with a simple circuit structure such that the duty ratio of a clock is adjusted so as to have a desired value.

Specifically, a data driver of the present invention is a data driver for a display device, which has a clock input, a clock output, a plurality of data inputs and a plurality of data outputs. The data driver includes an inverter chain, a smoothing circuit, a comparator, and latching means. The inverter chain includes a plurality of inverters which are serially connected to each other, a first current source connected to a power supply side of any one of the plurality of inverters, and a second current source connected to a ground side of any one of the plurality of inverters, wherein a first stage inverter of the plurality of inverters receives the clock input, and an end stage inverter of the plurality of inverters supplies the clock output. The smoothing circuit smoothes the clock output to obtain an average voltage. The comparator compares the average voltage with a reference voltage. If the average voltage is lower than the reference voltage, the comparator supplies a first control voltage to control the magnitude of an electric current in the first current source such that the duty ratio of the clock output increases. If the average voltage is higher than the reference voltage, the comparator outputs a second control voltage to control the magnitude of an electric current in the second current source such that the duty ratio of the clock output decreases. The latching means latches the plurality of data inputs in synchronization with the clock output and supplies results of the latches as the plurality of data outputs to a display section of the display device.

When the average voltage indicates that the duty ratio of the clock output is lower than a desired value, the magnitude of the electric current in the first current source is decreased, whereby the falling timing of the clock output is delayed. When the average voltage indicates that the duty ratio of the clock output is higher than the desired value, the magnitude of the electric current in the second current source is decreased, whereby the rising timing of the clock output is delayed. The rising and falling timings of the clock output are shifted in such a manner, whereby the margins of the setup time and hold time of data are readily secured.

Furthermore, a plurality of inverter chains for data (“data inverter chains”) are provided between the plurality of data inputs and the latching means. Each of the plurality of data inverter chains has the same internal structure as that of the inverter chain that supplies the clock output, and in each data inverter chain, an electric current control is performed based on the first and second control voltages. With such an arrangement, a result of a timing adjustment performed on the clock output can be reflected in the plurality of data outputs when the outputs of the data inverter chains are supplied to a subsequent data driver.

### BRIEF DESCRIPTION OF THE DRAWINGS

FIG. 1 is a plan view of a liquid crystal panel on which data drivers of the present invention are incorporated.

FIG. 2 is a block diagram showing an internal structure example of each of the data drivers shown in FIG. 1.

FIG. 3 is a circuit diagram showing an internal structure example of an inverter chain and smoothing circuit shown in FIG. 2.

FIG. 4 is a timing chart which illustrates the operation of the circuit shown in FIG. 3 under the condition that the duty ratio of a clock input is lower than 50%.

FIG. 5 is a timing chart which illustrates the operation of the circuit shown in FIG. 3 under the condition that the duty ratio of the clock input is higher than 50%.

FIG. 6 is a timing chart which illustrates the advantageous effects of the data driver of FIG. 2.

FIG. 7 is a circuit diagram showing a variation of the circuit of FIG. 3.

FIG. 8 is a timing chart which illustrates the operation of the circuit shown in FIG. 7 under the condition that the duty ratio of a clock input is lower than 50%.

FIG. 9 is a timing chart which illustrates the operation of the circuit shown in FIG. 7 under the condition that the duty ratio of the clock input is higher than 50%.

FIG. 10 is a block diagram showing a variation of the structure of FIG. 2.

FIG. 11 is a circuit diagram showing an internal structure example of a reference voltage generation circuit shown in FIGS. 3 and 7.

### DESCRIPTION OF THE PREFERRED EMBODIMENTS

Hereinafter, an embodiment of the present invention is described in detail with reference to the attached drawings.

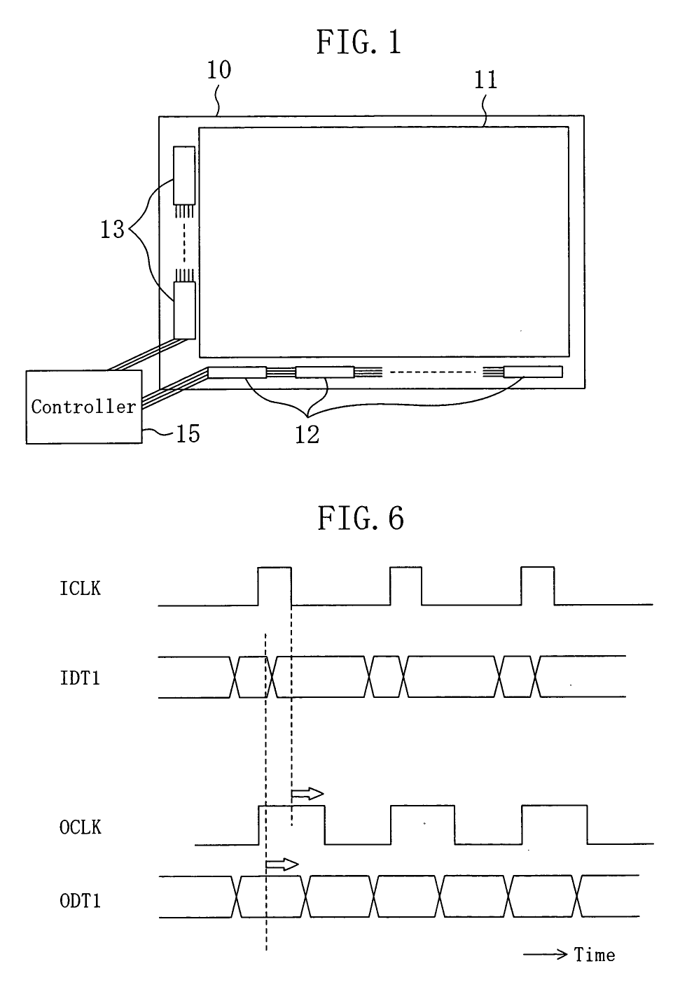

FIG. 1 shows a serial COG liquid crystal panel on which data drivers of the present invention are incorporated. The liquid crystal panel 10 shown in FIG. 1 includes a liquid crystal display section 11, a plurality of data drivers 12 and a plurality of gate drivers 13. Chips of the data drivers 12 are aligned along a horizontal side of the liquid crystal panel 10, and neighboring chips are connected by a single clock line and a plurality of data lines. Chips of the gate drivers 13 are aligned along a vertical side of the liquid crystal panel 10. A controller 15 supplies signals to the data driver 12 at the left end and to the gate driver 13 at the lowest end.

Each data driver 12 receives a single clock input and a plurality of data inputs. Each data driver 12 supplies a predetermined data voltage to the liquid crystal display section 11 and supplies the single clock input and the plurality of data inputs to a neighboring data driver 12.

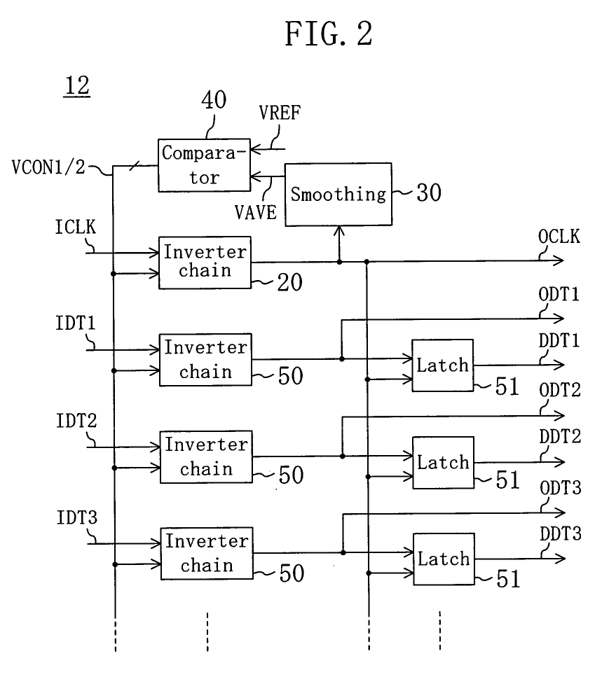

FIG. 2 shows an internal structure example of each data driver 12 of FIG. 1. The data driver 12 of FIG. 2 includes an inverter chain 20 for a clock (hereinafter, referred to as “clock inverter chain 20”), a smoothing circuit 30, a comparator 40, a plurality of inverter chains 50 for data (hereinafter, referred to as “data inverter chains 50”), and a plurality of latches 51. Reference marks ICLK denotes a clock input, OCLK denotes a clock output, IDT1, IDT2 and IDT3 denote data inputs, ODT1, ODT2 and ODT3 denote data outputs supplied to the adjacent data driver 12, and DDT1, DDT2 and DDT3 denote data outputs supplied to the liquid crystal display section 11.

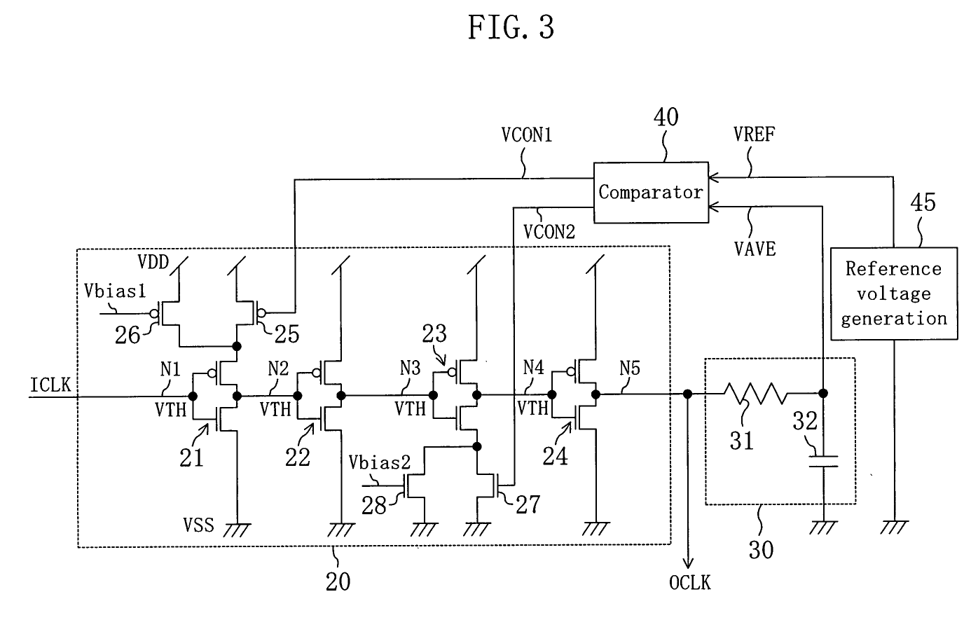

As shown in FIG. 3 in detail, the clock inverter chain 20 includes serially-connected first, second, third and fourth inverters 21, 22, 23 and 24, a first current source 25 connected to the power supply side of the first inverter 21, and a second current source 27 connected to the ground side of the third inverter 23. The first inverter 21 receives clock input ICLK, and the fourth inverter 24 outputs clock output OCLK. Each of the inverters 21 to 24 is formed by a P-channel type MOS (Metal Oxide Semiconductor) transistor and an N-channel type MOS transistor. The first current source 25 is formed by a P-channel type MOS transistor, and the second current source 27 is formed by an N-channel type MOS transistor. In FIG. 3, reference marks N1, N2, N3, N4 and N5 denote nodes. The node N1 is a terminal through which the clock is input, and the node N5 is a terminal through which the clock is output. Reference mark VDD denotes a supply voltage. Reference mark VSS denotes a ground voltage (=0 V). Reference mark VTH denotes a threshold voltage of the inverters 21 to 24.

The smoothing circuit 30 is an integrator including a resistor 31 and a capacitor 32. The smoothing circuit 30 smoothes clock output OCLK to obtain average voltage VAVE which is supplied to the comparator 40.

A reference voltage generation circuit 45 shown in FIG. 3 supplies reference voltage VREF to the comparator 40. It should be noted that the reference voltage generation circuit 45 may be provided outside the data driver 12.

The comparator 40 compares average voltage VAVE supplied to a non-inverted input terminal with reference voltage VREF supplied to an inverted input terminal. If VAVE<VREF, the comparator 40 outputs first control voltage VCON1 to control the magnitude of an electric current in the first current source 25 such that the duty ratio of clock output OCLK increases. If VAVE>VREF, the comparator 40 outputs second control voltage VCON2 to control the magnitude of an electric current in the second current source 27 such that the duty ratio of clock output OCLK decreases.

In FIG. 2, each of the data inverter chains 50, which are present between data inputs IDT1, IDT2 and IDT3 and the latches 51, has the same internal structure as that of the clock inverter chain 20 shown in FIG. 3. In each data inverter chain 50, an electric current control is performed based on first and second control voltages VCON1 and VCON2. The latches 51 latch outputs of corresponding data inverter chains 50 in synchronization with clock output OCLK supplied from the clock inverter chain 20 and output results of the latches as data outputs DDT1, DDT2 or DDT3.

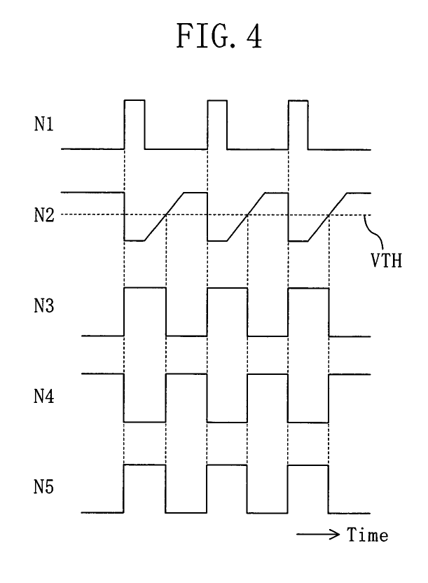

FIG. 4 illustrates the operation of the circuit shown in FIG. 3 under the condition that the duty ratio of clock input ICLK is lower than 50%. Herein, it is assumed that VREF=VTH=VDD/2 is satisfied. When clock input ICLK having a duty ratio of lower than 50% is supplied to the node N1, average voltage VAVE output from the smoothing circuit 30 is lower than VDD/2. Thus, the comparator 40 outputs first control voltage VCON1 such that the magnitude of the electric current in the first current source 25 is decreased and outputs second control voltage VCON2 such that the magnitude of the electric current in the second current source 27 is increased. Since the magnitude of the electric current in the first current source 25 is decreased, the charging rate from power supply VDD to the node N2 is decreased, so that the rising timing of the output of the first inverter 21 is delayed as seen in the voltage waveform at the node N2 shown in FIG. 4. Receiving this voltage waveform which has the delayed rising timing, the second inverter 22 does not perform an inverting operation until the voltage at the node N2 reaches threshold voltage VTH. As a result, the voltage at the node N3 has the waveform shown in FIG. 4. The third inverter 23 is connected to the second current source 27 as described above. The second current source 27 supplies a sufficient magnitude of electric current to the third inverter 23 such that the third inverter 23 performs a normal inverter operation. Thus, the voltage output by the third inverter 23, i.e., the voltage at the node N4, has the waveform shown in FIG. 4. Since the fourth inverter 24 is a general inverter, the voltage output by the fourth inverter 24, i.e., the voltage at the node N5, which is clock output OCLK, has the waveform shown in FIG. 4. As seen from a comparison of the waveforms at the nodes N1 and N5, the duty ratio of clock output OCLK is shifted toward 50% by shifting the falling timing of clock input ICLK.

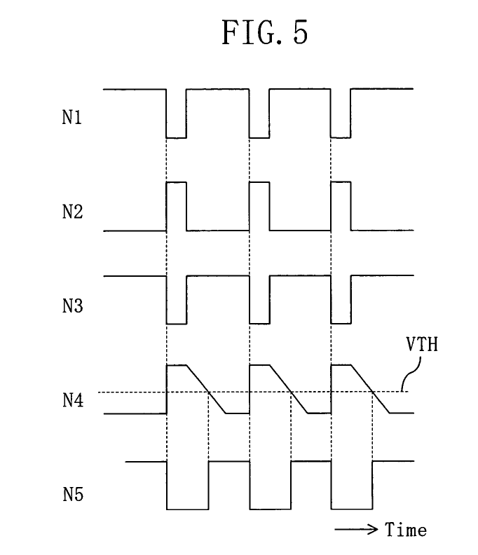

FIG. 5 illustrates the operation of the circuit shown in FIG. 3 under the condition that the duty ratio of clock input ICLK is higher than 50%. When clock input ICLK having a duty ratio of higher than 50% is supplied to the node N1, average voltage VAVE output from the smoothing circuit 30 is higher than VDD/2. Thus, the comparator 40 outputs first control voltage VCON1 such that the magnitude of the electric current in the first current source 25 is increased and outputs second control voltage VCON2 such that the magnitude of the electric current in the second current source 27 is decreased. Since the magnitude of the electric current in the first current source 25 is sufficient, the first inverter 21 operates as a general inverter so that the voltage output by the first inverter 21, i.e., the voltage at the node N2, has the waveform shown in FIG. 5. The second inverter 22 performs an inverting operation so that the voltage output by the second inverter 22, i.e., the voltage at the node N3, has the waveform shown in FIG. 5. In the third inverter 23, the discharging rate from the node N4 to ground VSS decreases because of the decrease in the magnitude of the electric current in the second current source 27. Thus, the falling timing of the output of the third inverter 23 is delayed as seen in the voltage waveform at the node N4 shown in FIG. 5. Receiving this voltage waveform which has the delayed falling timing, the fourth inverter 24 does not perform an inverting operation until the voltage at the node N4 reaches threshold voltage VTH. Thus, the voltage at the node N5 has the waveform shown in FIG. 5. As seen from a comparison of the waveforms at the nodes N1 and N5, the duty ratio of clock output OCLK is shifted toward 50% by shifting the rising timing of clock input ICLK.

FIG. 6 shows the waveforms of clock input ICLK, data input IDT1, clock output OCLK and data output ODT1 under the condition that the duty ratio of clock input ICLK is lower than 50%. Herein, it is assumed that the latches 51 shown in FIG. 2 latch data outputs ODT1, ODT2 and ODT3 at both the rising and falling edges of clock output OCLK.

In the situation shown in FIG. 6, the hold time of data input IDT1 is short with respect to a rising edge of clock input ICLK. However, in the data driver 12 shown in FIG. 2, the falling timing of clock output OCLK is delayed by the clock inverter chain 20, and the transition of data output ODT1 is delayed by the data inverter chain 50. Thus, data output ODT1 has a sufficient hold time with respect to the rising edge of clock output OCLK output from the clock inverter chain 20. As a result, the latch 51 appropriately latches data output ODT1. Clock output OCLK and data outputs ODT1, ODT2 and ODT3, whose timings have been adjusted as described above, are supplied to the data driver 12 of the next stage. It should be noted that the data driver 12 of FIG. 2 is helpful for securing the data setup time, although an illustration thereof is herein omitted.

The clock inverter chain 20 in FIG. 3 further includes a first auxiliary current source 26 connected in parallel to the first current source 25 and a second auxiliary current source 28 connected in parallel to the second current source 27. As shown in FIG. 3, constant bias voltage Vbias1 is supplied to the gate of a P-channel type MOS transistor which forms the first auxiliary current source 26, and constant bias voltage Vbias2 is supplied to the gate of an N-channel type MOS transistor which forms the second auxiliary current source 28. That is, the magnitudes of the electric currents in the first auxiliary current source 26 and the second auxiliary current source 28 are not controlled based on first control voltage VCON1 or second control voltage VCON2.

If the duty ratio of clock input ICLK is extremely low, there is a possibility that first control voltage VCON1 output from the comparator 40 excessively decreases the magnitude of the electric current in the first current source 25. In this case, the slope of a rising edge of the voltage at the node N2 is too moderate. As a result, when the frequency of clock input ICLK is high, the voltage at the node N2 does not exceed threshold voltage VTH of the second inverter 22 before clock input ICLK rises, and accordingly, the voltage at the node N2 does not rise to a high level. In order to prevent such a malfunction, according to the present embodiment, the first auxiliary current source 26 always supplies a small magnitude of electric current to the first inverter 21 such that the slope of a rising edge of the voltage at the node N2 is prevented from being too moderate. A malfunction of the same kind may occur when the duty ratio of clock input ICLK is extremely high, but it is prevented by the second auxiliary current source 28.

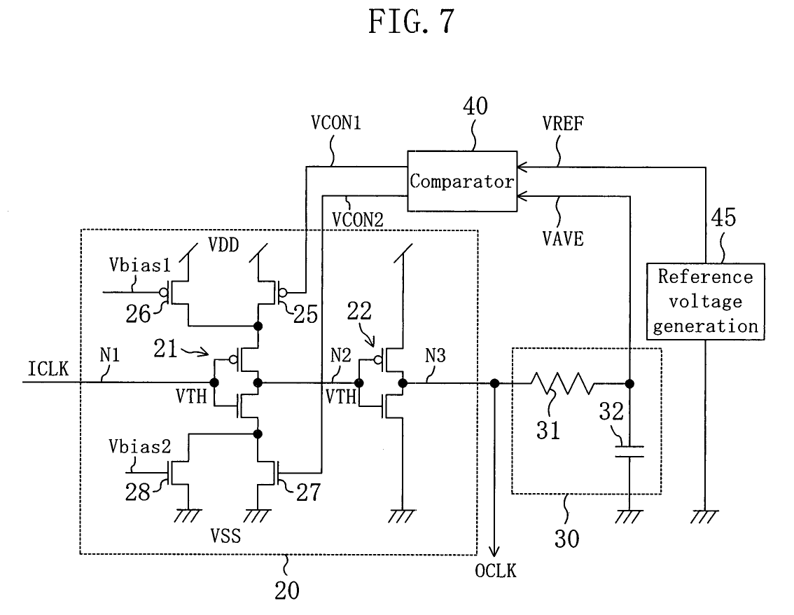

FIG. 7 shows a variation of the circuit of FIG. 3. A clock inverter chain 20 shown in FIG. 7 includes serially-connected first and second inverters 21 and 22, a first current source 25 and first auxiliary current source 26 which are connected in parallel to each other at the power supply side of the first inverter 21, and a second current source 27 and second auxiliary current source 28 which are connected in parallel to each other at the ground side of the first inverter 21. The first inverter 21 receives clock input ICLK, and the second inverter 22 outputs clock output OCLK.

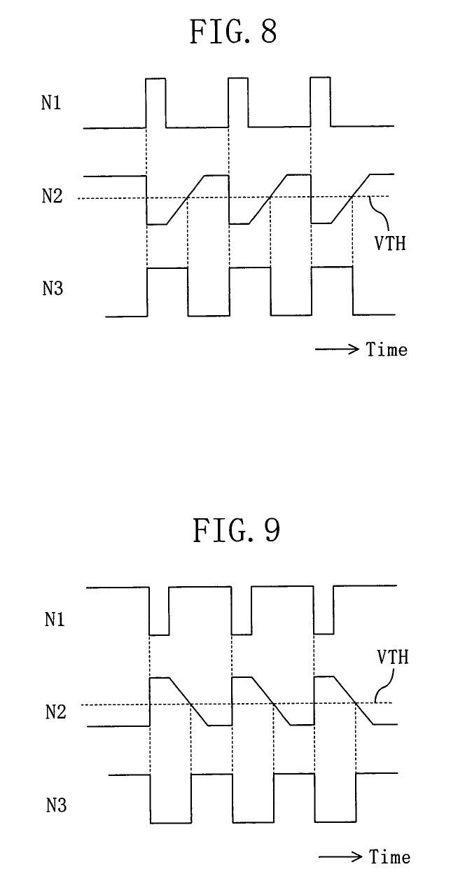

FIG. 8 illustrates the operation of the circuit shown in FIG. 7 under the condition that the duty ratio of clock input ICLK is lower than 50%. FIG. 9 illustrates the operation of the circuit shown in FIG. 7 under the condition that the duty ratio of clock input ICLK is higher than 50%. The circuit of FIG. 7 achieves the same effects as those of the circuit of FIG. 3 while the size of the circuit of FIG. 7 is smaller than that of the circuit of FIG. 3. Details of the operation of the circuit of FIG. 7 are herein omitted.

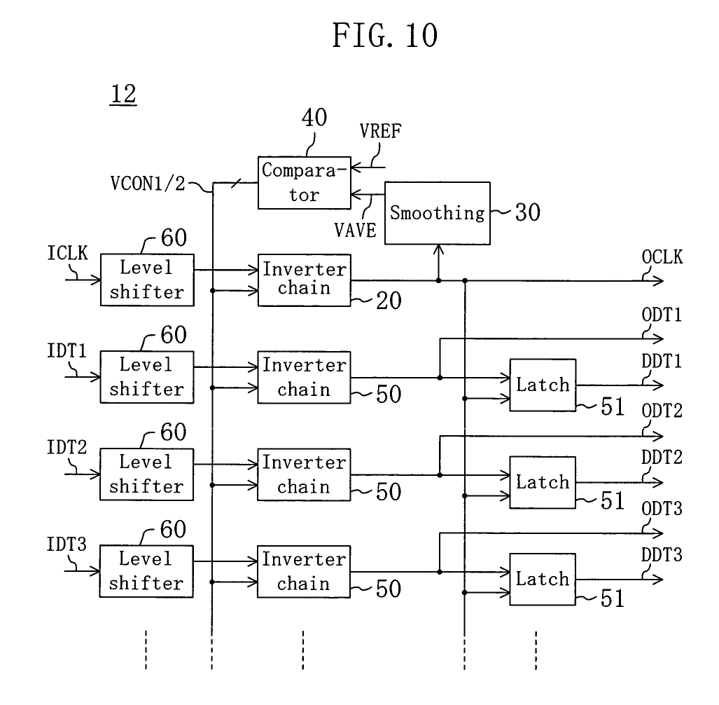

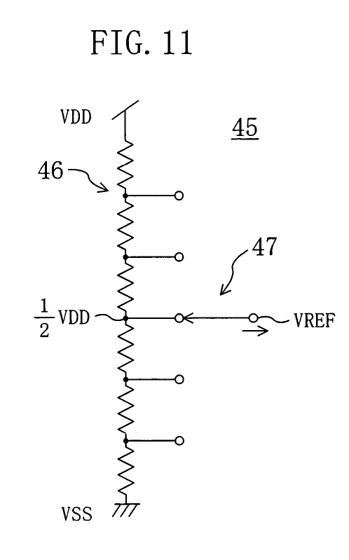

FIG. 10 shows a variation of the structure of FIG. 2. In the structure of FIG. 10, clock input ICLK and data inputs IDT1, IDT2 and IDT3, each of which has a small amplitude, are supplied to the data driver 12 for the purpose of reducing EMI (Electro-Magnetic Interference). A plurality of level shifters 60 are means for increasing the small amplitudes of clock input ICLK and data inputs IDT1, IDT2 and IDT3 to predetermined levels inside the data driver 12.

FIG. 11 shows an internal structure example of the reference voltage generation circuit 45 shown in FIGS. 3 and 7. The reference voltage generation circuit 45 of FIG. 11 is formed by a ladder resistor 46 and a switch 47 and supplies variable reference voltage VREF to the comparator 40. Also in this structure, if VREF=VDD/2, the duty ratio of clock output OCLK have a value near 50% as described above. Furthermore, the duty ratio of clock output OCLK can be adjusted so as to have a value lower than 50% by setting reference voltage VREF to be lower than VDD/2 by the switch 47. The duty ratio of clock output OCLK can be adjusted so as to have a value higher than 50% by setting reference voltage VREF to be higher than VDD/2 by the switch 47.

The number of inverters included in each of the inverter chains 20 and 50 is not limited to 4 or 2. In the case where only a tiny timing adjustment between clock input ICLK and clock output OCLK is performed, the data inverter chains 50 in FIGS. 2 and 10 may be omitted.

As described hereinabove, the data driver of the present invention is capable of securing the margins of a setup time and a hold time between a clock and data with a simple circuit structure, and is useful as a data driver for a high-definition display device, or the like.

What is claimed is:

1. A data driver for a display device which has a clock input, a clock output, a plurality of data inputs and a plurality of data outputs, the data driver comprising:
an inverter chain including
a plurality of inverters which are serially connected to each other,
a first current source connected to a power supply side of any one of the plurality of inverters, and
a second current source connected to a ground side of any one of the plurality of inverters,
wherein a first stage inverter of the plurality of inverters receives the clock input, and an end stage inverter of the plurality of inverters supplies the clock output;
a smoothing circuit for smoothing the clock output to obtain an average voltage;
a comparator for comparing the average voltage with a reference voltage, wherein if the average voltage is lower than the reference voltage, the comparator supplies a first control voltage to control the magnitude of an electric current in the first current source such that the duty ratio of the clock output increases, and if the average voltage is higher than the reference voltage, the comparator outputs a second control voltage to control the magnitude of an electric current in the second current source such that the duty ratio of the clock output decreases; and
latching means for latching the plurality of data inputs in synchronization with the clock output and supplying results of the latches as the plurality of data outputs to a display section of the display device.

2. A data driver according to claim 1, wherein:
the inverter chain includes serially-connected first, second, third and fourth inverters; and
the first current source is connected to a power supply side of the first inverter, and the second current source is connected to a ground side of the third inverter.

3. A data driver according to claim 1, wherein:
the inverter chain includes serially-connected first and second inverters; and
the first current source is connected to a power supply side of the first inverter, and the second current source is connected to a ground side of the first inverter.

4. A data driver according to claim 1, further comprising a plurality of data inverter chains between the plurality of data inputs and the latching means,
wherein each of the plurality of data inverter chains has the same internal structure as that of the inverter chain that supplies the clock output, and
in each data inverter chain, an electric current control is performed based on the first and second control voltages.

5. A data driver according to claim 1, wherein:
the inverter chain further includes
a first auxiliary current source connected in parallel to the first current source, and
a second auxiliary current source connected in parallel to the second current source; and
the first and second auxiliary current sources are not controlled based on the first or second control voltage.

6. A data driver according to claim 1, further comprising level shift means for increasing a small amplitude of each of the clock input and the plurality of data inputs to a predetermined level inside the data driver.

7. A data driver according to claim 1, further comprising a reference voltage generation circuit for supplying a variable reference voltage to the comparator.
